(19) United States
(12) Patent Application Publication
(10) Pub. No.: US 2025/0181240 A1
(43) Pub. Date: Jun. 5, 2025

(54) BLOCK-EFFICIENT WRITE POLICIES FOR MEMORY DEVICES

(71) Applicant: Micron Technology, Inc., Boise, ID (US)

(72) Inventors: Gary F. Besinga, Boise, ID (US); Michael G. Miller, Boise, ID (US); Tawalin Opastrakoon, Boise, ID (US); Nagendra Prasad Ganesh Rao, Folsom, CA (US); Che Chen, Boise, ID (US); Peter Feeley, Boise, ID (US); Sead Zildzic, JR., Folsom, CA (US)

(21) Appl. No.: 18/937,452

(22) Filed: Nov. 5, 2024

Related U.S. Application Data
(60) Provisional application No. 63/606,242, filed on Dec. 5, 2023.

(51) Int. Cl. G06F 3/06

(52) U.S. Cl. CPC G06F 3/0608; G06F 3/064; G06F 3/0647; G06F 3/0679

(57) ABSTRACT

A system includes a processing device, operatively coupled to a memory device, to perform operations including receiving data from a host system, in response to receiving the data, initiating a write operation to write the data to a set of cache blocks of the memory device, the set of cache blocks including a first cache block and a second cache block, determining whether the first cache block is fully written and whether an amount of data written to the second cache block is greater than or equal to a threshold amount of data, and in response to determining that the first cache block is fully written and that the amount of data written to the second cache block is greater than or equal to the threshold amount of data, causing the data written to the set of cache blocks to be written to a target block of the memory device.

### CROSS-REFERENCE TO RELATED APPLICATION(S)

The present application claims priority to U.S. Provisional Patent Application No. 63/606,242, filed on Dec. 5, 2023 and entitled “BLOCK-EFFICIENT WRITE POLICIES FOR MEMORY DEVICES”, the entire contents of which are hereby incorporated by reference herein.

### TECHNICAL FIELD

Embodiments of the disclosure relate generally to memory sub-systems, and more specifically, relate to block-efficient write policies for memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 is a diagram illustrating an example system to implement block-efficient write policies for memory devices, in accordance with some embodiments of the present disclosure.

FIG. 3 is a diagram illustrating an example target block to which data is migrated from a set of cache blocks, in accordance with some embodiments of the present disclosure.

FIG. 4 is a flow diagram of example methods for implementing block-efficient write policies for memory devices, in accordance with some embodiments of the present disclosure.

FIG. 5 is a flow diagram of example methods for addressing interruptions to data flow during block-efficient write policies for memory devices, in accordance with some embodiments of the present disclosure.

FIG. 6 is a block diagram of an example computer system in which embodiments of the present disclosure may operate.

### DETAILED DESCRIPTION

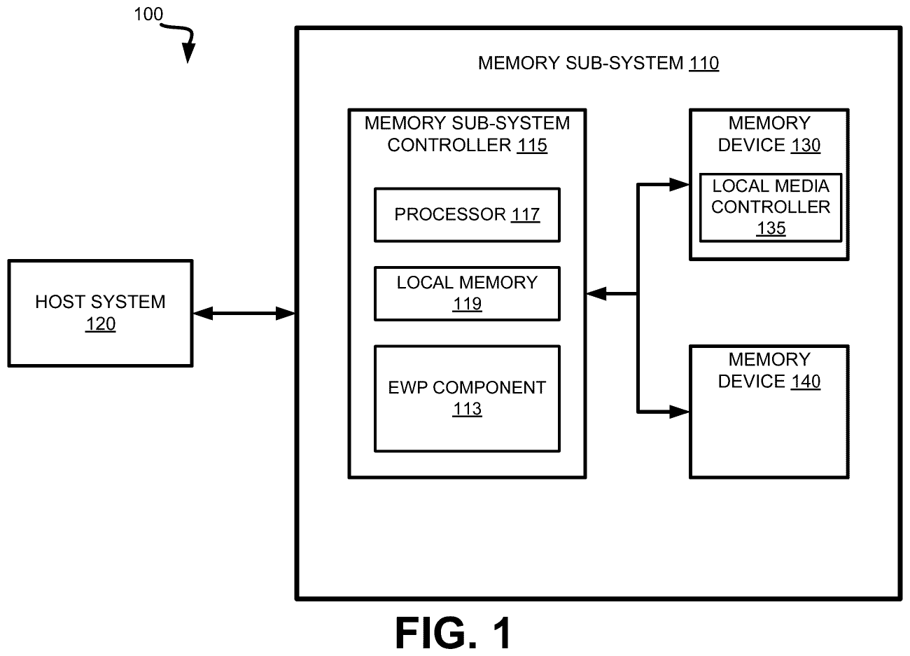

Aspects of the present disclosure are directed to block-efficient write policies for memory devices. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple bits arranged in a two-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system. The data to be read or written, as specified by a host request, is hereinafter referred to as “host data”. A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g. used to distinguish age of data written), valid bitmap (which LBAs or logical transfer units contain valid data), etc.

A memory cell (“cell”) can be programmed (written to) by applying a certain voltage to the cell, which results in an electric charge being held by the cell. For example, a voltage signal VCG that can be applied to a control electrode of the cell to open the cell to the flow of electric current across the cell, between a source electrode and a drain electrode. More specifically, for each individual cell (having a charge Q stored thereon) there can be a threshold control gate voltage V_{T} (herein also referred to as the “threshold voltage” or simply as “threshold”) such that the source-drain electric current is low for the control gate voltage (V_{C}G) being below the threshold voltage, VCG<V_{T}. The current increases substantially once the control gate voltage has exceeded the threshold voltage, VCG>V_{T}. Because the actual geometry of the electrodes and gates varies from cell to cell, the threshold voltages can be different even for cells implemented on the same die. The cells can, therefore, be characterized by a distribution P of the threshold voltages, P(Q,V_{T})=dW/dV_{T}, where dW represents the probability that any given cell has its threshold voltage within the interval [V_{T},V_{T}+dV_{T}] when charge Q is placed on the cell.

A memory device can have distributions P(Q,V_{T}) that are narrow compared with the working range of control voltages tolerated by the cells of the device. Accordingly, multiple non-overlapping distributions P(Qₖ,V_{T}) (“valleys”) can be fit into the working range allowing for storage and reliable detection of multiple values of the charge Qₖ, k=1, 2, 3 . . . . The distributions (valleys) are interspersed with voltage intervals (“valley margins”) where none (or very few) of the cells of the memory device have their threshold voltages. Such valley margins can, therefore, be used to separate various charge states Qₖ—the logical state of the cell can be determined by detecting, during a read operation, between which two valley margins the respective threshold voltage V_{T} of the cell resides. Specifically, the read operation can be performed by comparing the measured threshold voltage V_{T} exhibited by a cell to one or more reference voltage levels corresponding to known valley margins (e.g., centers of the margins).

A memory device can include multiple cells, each of which can store, depending on the type of cell, one or more bits of information. One type of cell is a single level cell (SLC), which stores 1 bit per cell and defines 2 logical states (“states”) (“1” or “L0” and “0” or “L1”) each corresponding to a respective V_{T} level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective V_{T} level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective V_{T} level. For example, the “111” state can be an erased state and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2″ levels of charge to store n bits. A memory device can include one or more arrays of cells such as SLCs, MLCs, TLCs, QLCs, PLCs, etc. or any combination of such. For example, a memory device can include an SLC portion, and an MLC portion, a TLC portion, a QLC portion, or a PLC portion of memory cells.

Some memory sub-systems (e.g., SSDs) implement caching architecture for storing data received from a host device. More specifically, a memory sub-system can include a cache including a set of cache blocks including first XLC cells of a first type, in which data written to the cache can eventually be written to a target block including second XLC cells of a second type. An XLC cell refers to an x-level cell that stores x-bits of state information per cell, where x is a positive integer. For example, an XLC cell can be an SLC cell, an MLC cell, a TLC cell, a QLC cell, a PLC cell, etc., as described above.

The first XLC cells can store fewer bits of state information per cell than the second XLC cells of the target block. In some embodiments, the first XLC cells include SLC cells (“SLC cache”) and the second XLC cells include non-SLC cells. For example, the second XLC cells can include QLC cells (“QLC block”). In such an example, one bit stored in SLC cache can take up the same amount of space as four bits stored in a QLC target block.

The size of the cache (e.g., SLC cache) can be selected in view of physical memory device constraints. For example, the size of the cache can have a fixed size that does not exceed the available number of blocks on the memory device (e.g., NAND). The cache can include a static cache having a fixed logical saturation size (“fixed size”) and/or a dynamic cache having a dynamic (e.g. modifiable or configurable) maximum logical saturation size (“dynamic maximum size”). Logical saturation refers to a portion of logical locations (e.g., LBAs) that contain data (e.g., a ratio of the size of the logical locations that contain data to the total size of the logical locations). Thus, logical saturation can refer to an amount of data logically written to the memory sub-system from the perspective of the host system. In contrast to logical saturation, physical saturation refers to a portion of physical locations (e.g., physical NAND locations) that contain data (e.g., a ratio of the size of the physical locations that contain data to the total size of the physical locations). The memory sub-system can utilize a cache behavior profile specifying at least one of: size rules of the cache (e.g., rules for increasing or decreasing the cache), usage rules of the cache, rules specifying the location of the cache, etc. The cache behavior profile may include a single configuration rule, or multiple rules. For example, an initial cache behavior profile may be loaded by a manufacturer onto the memory sub-system at the time of manufacture. The cache behavior profile can be a static profile that remains unchanged over time. For example, the initial cache behavior profile can persist through the life of the memory sub-system. Alternatively, the cache behavior profile can be a dynamic profile that can be updated or replaced with an updated cache behavior profile via a communications interface. For example, device usage characteristics may change (e.g., usage behavior of the device in which the memory sub-system is installed), and thus the host may replace the cache behavior profile over the communications interface. Illustratively, a smartphone may receive an over the air (OTA) update that specifies an updated SLC cache behavior profile that modifies the performance characteristics of the memory sub-system in response to a change in usage behavior of the smartphone.

It can be advantageous to implement a cache policy that can avoid partially filling a target block with data received by the cache from a host device during a write operation (e.g., to improve data integrity). Such a cache policy can create some limitations on the cache at least for some workloads, such as increased consumption of blocks to maintain host write performance. Accordingly, such cache policies can be difficult to support as the number of available blocks decreases due to the continued memory device scaling.

For example, one example of such a cache policy includes filling each cache block of a set of cache blocks prior to migrating the data from the set of cache blocks to a target block. For example, if the set of blocks includes a set of SLC cache blocks and the target block is a QLC block, then the set of cache blocks can include four SLC cache blocks. Thus, the QLC block can be written to after all four SLC cache blocks are filled, which will fill the QLC block. After completion of the write operation to migrate the data from the set of cache blocks to the target block, a logical-to-physical (L2P) mapping table can be updated. Then, the set of cache blocks can be released and erased.

With some workloads, such as sequential workloads, the set of cache blocks can include fully valid data that can guarantee cache block to target block boundaries. Other workloads can cause LBA over-writes in the cache blocks, which can cause garbage collection to occur during the migration of the data from the set of cache blocks to the target block (which can result in some cache blocks having invalid data). In these cases, other data from another data source can be used to fill the target block and complete target block programming.

To stream data from a host system to cache at a constant or near-constant rate in accordance with the cache policy described above, a caching architecture can implement double-buffering. To implement double-buffering, the caching architecture can include a first set of cache blocks from which data is migrated to a target block, and a second set of cache blocks to which data from the host system can be written separately from the data migration to the target block. However, this caching architecture can utilize a large number of blocks to maintain the constant or near-constant data stream rate. For example, in the case of migrating data from an SLC cache including four SLC cache blocks to a QLC block, the caching architecture can include a minimum of nine SLC blocks to implement double-buffering. More specifically, the nine SLC blocks can include four SLC cache blocks of the SLC cache, four SLC cache blocks of the cache buffer, and one SLC block corresponding to the other source of data.

Aspects of the present disclosure address the above and other deficiencies by enabling memory devices to implement block-efficient write policies for migrating data (e.g., host data) from a set of cache blocks to a target block. A memory sub-system controller can receive data from a host system for writes to the target block of a memory device. The memory sub-system controller can cause the data received from the host system to be written to a target block of the memory device by implementing a caching architecture. For example, the caching architecture can be formed with a set of cache blocks including first XLC cells of a first type, and a target block including second XLC cells of a second type. The first XLC cells can store fewer bits of state information per cell than the second XLC cells of the target block. In some embodiments, the first XLC cells include SLC cells (“SLC cache”) and the second XLC cells include non-SLC cells. For example, the second XLC cells can include QLC cells (“QLC block”). In such an example, one bit stored in SLC cache can take up the same amount of space as four bits stored in a QLC target block.

Embodiments described herein can be used to stream data from the host system to the cache for migration into target storage at a constant or near-constant rate without using double-buffering. For example, a memory sub-system controller can copy and/or garbage collect cache blocks into target blocks one at a time. The caching architecture can include a set of cache blocks including a first cache block and a second cache block. In some embodiments, the second cache block is another data source external to the set of cache blocks.

To initially write data to a target block (e.g., empty target block), the memory sub-system controller can determine whether an amount of data written to the set of cache blocks satisfies a threshold condition. For example, the data can be received from a host system. Determining whether the amount of data written to the set of cache blocks satisfies a threshold condition can include determining whether the first cache block is filled with data, and determining whether the second cache block is filled with at least a threshold amount of data (e.g., minimum amount of data). The threshold condition is selected to help maintain data integrity and reliability. For example, the threshold amount of data written to the set of cache blocks can provide a buffer to help ensure data integrity and reliability. In some embodiments, the threshold amount of data corresponds to a threshold number of wordlines of the target block.

If the amount of data written to the set of cache blocks satisfies the threshold condition (e.g., the first cache block is filled with data and the second cache block is filled with at least the threshold amount of data), then the data written to the first cache block and the data written to the second cache block can be migrated to the target block. To illustrate, assume that the threshold amount of data corresponds to two wordlines of the target block. Upon filling the first cache block and partially filling the second cache block with an amount of data equal to two wordlines of the target block, the memory sub-system controller can cause the data written to the first cache block and the data written to the second cache block to be migrated to the target block.

Then, the memory sub-system controller can proceed to update the L2P mapping table, and erase (e.g., release) the first cache block. For example, updating the L2P mapping table can include causing the first cache block to be remapped to the target block within the L2P mapping table. The memory sub-system controller can then continue writing to the target block (e.g., resuming from the second cache block).

With a steady supply of data (either from static or dynamic cache), data streaming can be maintained without loss in performance. However, there may be some interrupt events that may interrupt target block programming, which and can impact data integrity and reliability of data written to a partially written target block in accordance with the block-efficient write policy described herein. An interrupt event can be a predicted interrupt event in which an interrupt event is predicted ahead of time, or an unpredicted interrupt event in which an interrupt event occurs without warning. For example, an interrupt event can include a power loss event, a predicted interrupt event can include a power down event in response to a power down request, and an unpredicted interrupt event can include an asynchronous power loss event.

A partially written target block can include multiple sections. One section can be a previously written data section that includes data that has been previously L2P mapped in the L2P mapping table. Data of the previously written data section should guarantee data integrity and reliability characteristics and management policies.

Another section can include an interrupted programming section. Data in this section is written to the target block, but has not yet been L2P mapped in the L2P mapping table and the source of the data (e.g., cache block) has not been erased (e.g., released). Data integrity and reliability is not guaranteed or required for such data, and data from the source will need to be rewritten. For example, such data can include data written from the next data source (e.g., written to one or more wordlines of the target block).

Yet another section can include an unwritten section. Ideally, data can be reliably appended to the unwritten section to avoid the target block copying previously written data. The potential impact on write amplification can be balanced with data integrity and reliability concerns.

To address interrupt events, the memory sub-system controller can deploy additional policies to improve data integrity and reliability of data written to a target block in accordance with the block-efficient write policy described herein. For example, in the case of a predicted interrupt event (e.g., power down request), the memory sub-system controller can determine whether a length of time that a target block has remained open satisfies a threshold condition, and can cause writing to the target block to resume after the predicted interrupt event if the length of time satisfies the threshold condition. In some embodiments, the memory sub-system controller can cause a scan to be performed to determine (e.g., indirectly determine) the length of time that the target block has remained open. In some embodiments, determining whether the length of time satisfies the threshold condition can include determining whether the length of time is less than or equal to a threshold amount of time. The threshold amount of time can correspond to a maximum amount of time that the target block should remain open for purposes of data integrity and reliability. Thus, if the length of time that the target block has remained open does not satisfy the threshold condition (e.g., the length of time is greater than the threshold amount of time), then the memory sub-system controller can cause the target block to be abandoned (e.g., closed prevent further writes to the target block). The memory sub-system controller can then open a new target block, migrate data from the target block to the new target block, and resume data writes to the new target block.

In the case of an unpredicted interrupt event, there may be multiple options. For example, as a first option, the memory sub-system controller can cause dummy data to be written to the interrupted programming section of the partially written target block for padding. In some embodiments, the memory sub-system controller causes dummy data to be written to at least one wordline of the interrupted programming section. The memory sub-system controller can then cause writes to the target block to resume at the next wordline (the wordline adjacent to the last dummy data wordline). As another example, as a second option, the memory sub-system controller can cause the target block to be abandoned. The memory sub-system controller can move data from the previously written data section (e.g., L2P mapped data) to a new target block.

The memory sub-system controller can determine which option to perform by determining whether a length of time that a target block has remained open satisfies a threshold condition (e.g., similar to the process described above). If the length of time satisfies the threshold condition (e.g., is less than or equal to a threshold amount of time), then the memory sub-system controller can keep the target block open and select the first option by causing the dummy data to be written to the interrupted programming section. Otherwise, the memory sub-system controller can determine that the target block should be closed and select the second option to migrate the data from the previously written section to the new target block. Further details regarding the operations performed by the memory sub-system controller to implement block-efficient write policies for memory devices will be described below with reference to FIGS. 1-5.

Advantages of the present disclosure include, but are not limited to, improved memory device performance and QoS. For example, implementations described herein can enable sequential write performance with reduced computational resource consumption (e.g., by eliminating the use of double-buffering).

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

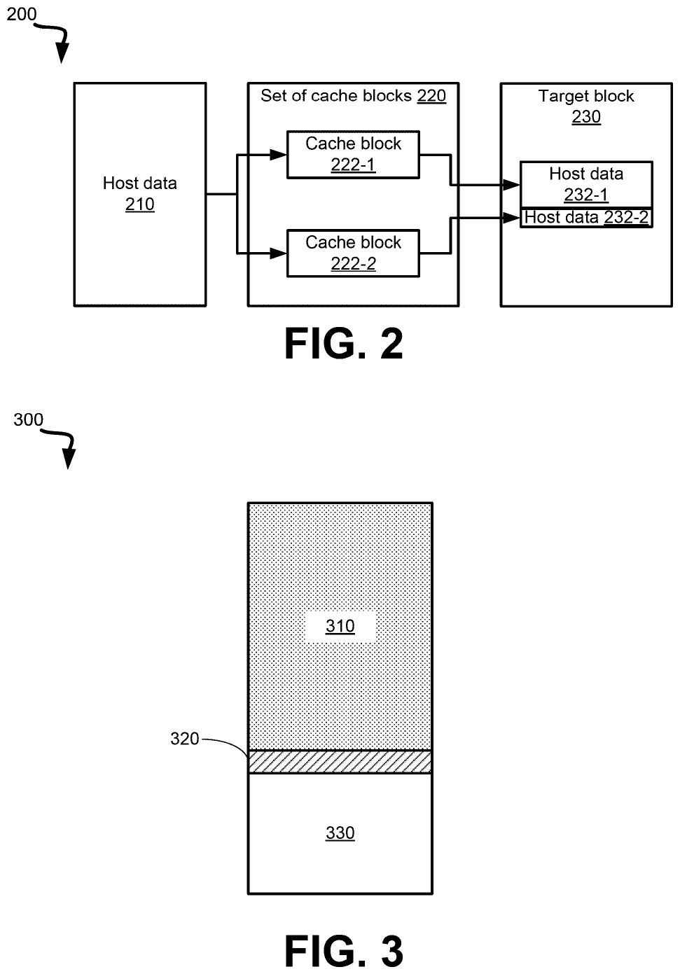

The memory sub-system 110 includes an enhanced write performance (EWP) component 113. In some embodiments, the memory sub-system controller 115 includes at least a portion of the EWP component 113. In some embodiments, the EWP component 113 is part of the host system 120, an application, or an operating system. In other embodiments, local media controller 135 includes at least a portion of EWP component 113 and is configured to perform the functionality described herein. As will now be described below with reference to FIGS. 2-5, EWP component 113 can enhanced write performance using a block-efficient write policy.

FIG. 2 is a diagram illustrating an example system to implement block-efficient write policies for memory devices, in accordance with some embodiments of the present disclosure. System 200 shows host data 210 received by a memory sub-system (e.g., memory sub-system 110 of FIG. 1) from a host system (e.g., host system 120 of FIG. 1).

A controller of the memory sub-system (e.g., memory sub-system controller 115 implementing EWP component 113 of FIG. 1) can initiate a write operation to write host data 210 to set of cache blocks 220. Set of cache blocks 220 can include cache block 222-1 and cache block 222-2. At least the cache block 222-1 can include cells having a first type. In some embodiments, the cells having the first type are SLC cells. However, such an example should not be considered limiting.

The memory sub-system controller can determine whether the amount of data written to set of cache blocks 220 satisfies a threshold condition. The threshold condition is selected to help maintain data integrity and reliability. For example, the threshold amount of data written to set of cache blocks 220 can provide a buffer to help ensure data integrity and reliability. In some embodiments, determining whether an amount of the data written to set of cache 220 blocks satisfies a threshold condition includes determining whether cache block 222-1 is fully written and that an amount of data written to the cache block 222-2 is greater than or equal to a threshold amount of data.

If the amount of data written to set of cache blocks 220 satisfies the threshold condition, then the data written to set of cache blocks 220 can be written to target block 230. More specifically, writing the data to target block 230 can include migrating the data from set of cache blocks 220 to the target block. For example, writing the data to target block 230 can include writing, to target block 230, host data 232-1 of cache block 222-1 (e.g., a fully filled cache block), and host data 232-2 from cache block 222-2 (e.g., a partially filled cache block).

In some embodiments, the threshold amount of data corresponds to a threshold number of wordlines of target block 230. To illustrate, assume that the threshold amount of data corresponds to two wordlines of target block 230. After determining that cache block 222-1 is filled with data including host data 232-1, and cache block 222-2 is at least partially filled with host data 232-2 corresponding to an amount of data equal to two wordlines of target block 230, the memory sub-system controller can cause data including host data 232-1 and host data 232-2 to be written (e.g., migrated) to target block 230.

After the data is migrated to target block 230, the memory sub-system controller can an erase operation to erase at least cache block 222-1. For example, the erase operation scan erase (e.g., release) at least cache block 222-1. Erasing cache block 222-1 can include causing cache block 222-1 to be remapped within the L2P mapping table (e.g., updating the L2P mapping table), and causing the cache block 222-1 to be erased (e.g., released) after causing cache block 222-1 to be remapped. For example, the L2P mapping table can be updated to point to host data 232-1, instead of cache block 222-1.

If the write operation is not complete, then additional data from the host system can then be written to set of cache blocks 220 including cache block 222-2. Similar to the above, the memory sub-system controller can determine whether the amount of data written to set of cache blocks 220 satisfies the threshold condition. For example, determining whether the amount of data written to set of cache blocks 220 satisfies the threshold condition can include determining whether cache block 222-2 is fully written and an amount of data written to a third cache block (e.g., the previously erased cache block 222-1 or some other cache block of set of cache blocks 220-2, not shown) is greater than or equal to the threshold amount of data.

In some embodiments, the memory sub-system controller detects an interrupt event with respect to data being written to target block 230. More specifically, the interrupt event is an event that interrupts programming of target block 230. For example, an interrupt event can be a power loss event. An interrupt event can be a predicted interrupt event (e.g. requested power loss event) or an unpredicted interrupt event (e.g., asynchronous power loss event).

Target block 230 can be a partially written block that can be divided into multiple sections. For example, target block 230 can include a previously written data section that includes data that has been previously L2P mapped in the L2P mapping table. Data of the previously written data section should guarantee data reliability characteristics and management policies. As another example, target block 230 can include an interrupted programming section. Data in this section is written to target block 230, but has not yet been L2P mapped in the L2P mapping table and the source of the data (e.g., cache block) has not be erased (e.g., released). Data reliability is not guaranteed or required for such data, and data from the source will need to be rewritten. For example, such data can include data written from the next data source (e.g., written to one or more wordlines of target block 230). As yet another example, target block 230 can include an unwritten section. Ideally, data can be reliably appended to the unwritten section to avoid the target block copying previously written data. The potential impact on write amplification can be balanced with data reliability concerns. Further details regarding the sections of target block 230 will be described in further detail below with reference to FIG. 3.

The memory sub-system controller can determine whether to continue writing to target block 230 after the interrupt event and either cause the write operation to continue or cause target block 230 to be abandoned based on the determination. In some embodiments, determining whether to continue writing to target block 230 after the interrupt event includes determining whether a length of time that target block 230 has remained open satisfies a threshold condition. For example, processing logic can cause a scan to be performed to determine (e.g., indirectly determine) the length of time that target block 230 has remained open. In some embodiments, determining whether the length of time satisfies the threshold condition can include determining whether the length of time is less than or equal to a threshold amount of time. The threshold amount of time can correspond to a maximum amount of time that target block 230 should remain open for purposes of data reliability and integrity.

If the memory sub-system controller determines to continue writing to target block 230 (e.g., the length of time is less than or equal to the threshold amount of time), then the memory sub-system controller can cause the write operation to continue to write data to target block 230. If the memory sub-system controller determines not to continue writing to target block 230 (e.g., the length of time is greater than the threshold amount of time), then the memory sub-system controller can cause target block 230 to be abandoned. For example, causing target block 230 to be abandoned can include causing target block 230 to close to prevent further writes to target block, opening a new target block (not shown), and migrating data written to the previously written data section of target block 230 to the new target block. The memory sub-system controller can then cause the write operation to continue by initiating the write operation to write the data to the new target block.

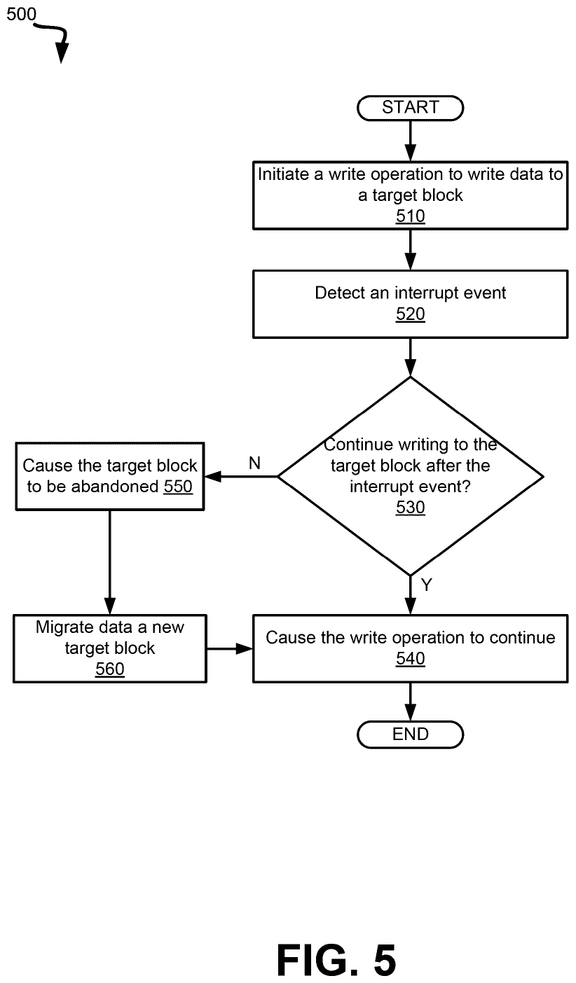

Illustratively, in the case of an unpredicted interrupt event, there may be multiple options. For example, as a first option, the memory sub-system controller can cause dummy data to be written to the interrupted programming section of target block 230 for padding. In some embodiments, the memory sub-system controller causes dummy data to be written to at least one wordline of the interrupted programming section of target block 230. The memory sub-system controller can then cause writes to target block 230 to resume at the next wordline (the wordline adjacent to the last dummy data wordline). As another example, as a second option, the memory sub-system controller can cause target block 230 to be abandoned. The memory sub-system controller can move data from the previously written data section (e.g., L2P mapped data) of target block 230 to the new target block. The memory sub-system controller can determine which option to perform by determining whether a length of time that target block 230 has remained open satisfies a threshold condition (e.g., similar to the process described above). If the length of time satisfies the threshold condition (e.g., is less than or equal to a threshold amount of time), then the memory sub-system controller can keep target block 230 open and select the first option by causing the dummy data to be written to the interrupted programming section of the target block. Otherwise, the memory sub-system controller can determine that the target block should be closed and select the second option to migrate the data from the previously written section of target block 230 to the new target block. Further details regarding operations performed by the memory sub-system controller to address interrupt events will be described below with reference to FIGS. 3 and 5.

FIG. 3 is a diagram illustrating an example target block 300, in accordance with some embodiments of the present disclosure. For example, target block 300 can be similar to target block 230 of FIG. 2. Target block 300 is shown as a partially written block divided into multiple sections. For example, target block 300 can represent a state of a target block after an interrupt event is detected (e.g., predicted interrupt event or unpredicted interrupt event). Further details regarding interrupt events are described above with reference to FIG. 2 and will be described in further detail below with reference to FIG. 5.

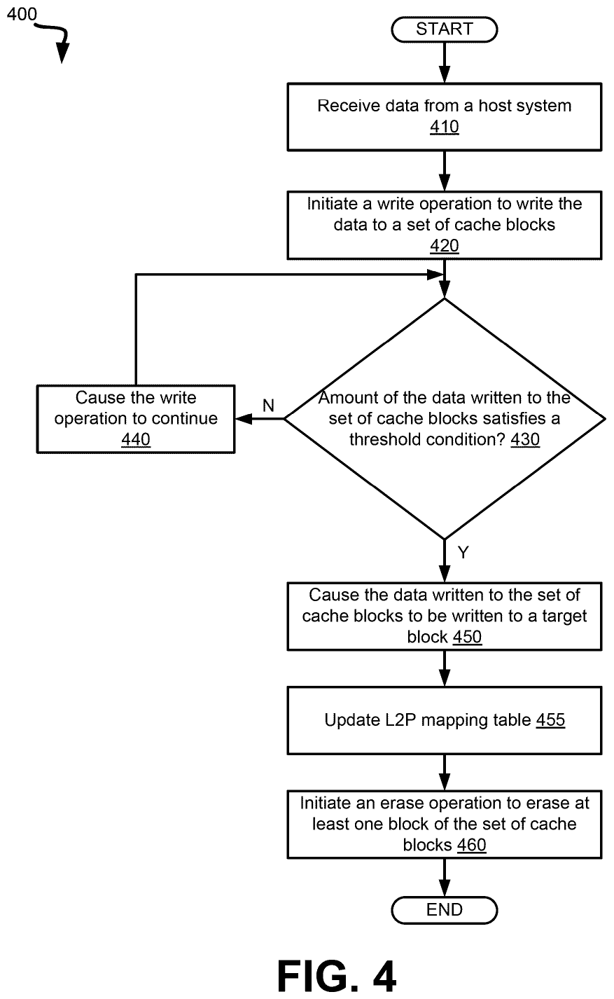

For example, target block 300 can include previously written data section 310, interrupted programming section 320, and unwritten section 330. Previously written data section 310 includes data that has been previously L2P mapped in a L2P mapping table. Data of previously written data section 310 should guarantee data integrity and reliability characteristics and management policies. Interrupted programming section 320 includes data is written to target block 300, but has not yet been L2P mapped in the L2P mapping table and the source of the data (e.g., cache block) has not been erased (e.g., released). Data integrity and reliability is not guaranteed or required for data of interrupted programming section 320, and data from the source will need to be rewritten. For example, data of interrupted programming section 320 can include the data from the second cache block (e.g., host data 232-2 of FIG. 2) that was written to target block 300 to improve data integrity and reliability for the data from the first cache block (e.g., host data 232-1 of FIG. 1). For example, the data of interrupted programming section 320 can be written to at least two wordlines of target block 300). Unwritten section 330 lacks data. Ideally, data can be reliably appended to unwritten section 330 to avoid target block 330 copying previously written data. The potential impact on write amplification can be balanced with data integrity and reliability concerns. Further details regarding target block 300 are described above with reference to FIG. 2 and will now be described below with reference to FIGS. 4-5.

FIG. 4 is a flow diagram of an example method 400 for implementing block-efficient write policies for memory devices, in accordance with some embodiments of the present disclosure. Method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 is performed by EWP component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, processing logic receives data from a host system. For example, the host system can be the host system 120 of FIG. 1.

At operation 420, processing logic initiates a write operation to write the data to a set of cache blocks. The set of cache blocks can include at least a first cache block and a second cache block. At least the first cache block can include cells having a first type. In some embodiments, the cells having the first type are SLC cells. However, such an example should not be considered limiting.

At operation 430, processing logic determines whether an amount of the data written to the set of cache blocks satisfies a threshold condition. The threshold condition is selected to help maintain data integrity and reliability. For example, the threshold amount of data written from the second cache block can provide a buffer to help ensure data integrity and reliability. In some embodiments, determining whether an amount of the data written to the set of cache blocks satisfies a threshold condition includes determining whether the first cache block is fully written and that an amount of data written to the second cache block is greater than or equal to a threshold amount of data.

At operation 440, if the amount of data written to the set of cache blocks does not satisfy the threshold condition, then processing logic causes the write operation to continue.

At operation 450, if the amount of data written to the set of cache blocks satisfies the threshold condition, then processing logic causes the data written to the set of cache blocks to be written to a target block. In some embodiments, the target block is an empty block. The target block can include cells having a second type different from the first type. More specifically, the cells having the second type store more bits per cell than cells having the first type. In some embodiments, the cells having the second type are QLC cells. Accordingly, in some embodiments, at least the first cache block includes SLC cells and the target block includes QLC cells.

More specifically, writing the data to the target block can include migrating the data from the set of cache blocks to the target block. For example, writing the data to the target block can include writing, to the target block, the data from the first cache block (e.g., a filled cache block), and the data from the second cache block (e.g., a partially filled cache block).

In some embodiments, the threshold amount of data corresponds to a threshold number of wordlines of a target block to which the data written to the set of cache blocks will be written to. To illustrate, assume that the threshold amount of data corresponds to two wordlines of the target block. After determining at operation 450 that the first cache block is filled with data and the second cache block is filled (e.g., partially filled) with an amount of data equal to two wordlines of the target block, processing logic can cause the data written to the set of cache blocks to be written (e.g., migrated) to the target block.

At operation 455, processing logic updates the L2P mapping table. For example, updating the L2P mapping table can include causing the first cache block to be remapped to the target block within the L2P mapping table.

At operation 460, processing logic initiates an erase operation to erase at least one block of the set of cache blocks. In some embodiments, the erase operation is initiated after updating the L2P mapping table. In some embodiments, the L2P mapping table is updated as part of the erase operation. For example, the erase operation scan erase (e.g., release) at least the first cache block.

If the write operation is not complete, then additional data from the host system can then be written to the set of cache blocks including the second cache block. Similar to operation 430, processing logic can determine whether the amount of data written to the set of cache blocks satisfies the threshold condition. For example, determining whether the amount of data written to the set of cache blocks satisfies the threshold condition can include determining whether the second cache block is fully written, and an amount of data written to a third cache block (e.g., the previously erased first cache block or some other cache block) is greater than or equal to the threshold amount of data. Further details regarding operations 410-460 are described above with reference to FIGS. 1-3.

In some embodiments, an interrupt event with respect to data being written to the target block is detected. More specifically, an interrupt event interrupts programming of the target block. For example, an interrupt event can include a power loss event. An interrupt event can be a predicted interrupt event (e.g. requested power loss event) or an unpredicted interrupt event (e.g., asynchronous power loss event). As described above with reference to FIGS. 1-3 and as will now be described below with reference to FIG. 5, processing logic can determine whether to continue writing to the target block after the interrupt event and either cause the write operation to continue or cause the target block to be abandoned based on the determination.

FIG. 5 is a flow diagram of an example method 500 for implementing block-efficient write policies for memory devices, in accordance with some embodiments of the present disclosure. Method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 500 is performed by the EWP component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, processing logic initiate a write operation to write data to a target block. The write operation and the target block can be similar to the write operation and the target block of FIG. 4.

At operation 520, processing logic detects an interrupt event with respect to data being written to the target block. More specifically, the interrupt event is an event that interrupts programming of the target block. In some embodiments, the interrupt event is a power loss event. In some embodiments, the interrupt event is a predicted interrupt event (e.g., requested power loss event). In some embodiments, the interrupt event is an unpredicted interrupt event (e.g., asynchronous power loss event).

The target block can be a partially written block that can be divided into multiple sections. For example, the target block can include a previously written data section that includes data that has been previously L2P mapped in the L2P mapping table. Data of the previously written data section should guarantee data integrity and reliability characteristics and management policies.

As another example, the target block can include an interrupted programming section. Data in this section is written to the target block, but has not yet been L2P mapped in the L2P mapping table and the source of the data (e.g., cache block) has not been erased (e.g., released). Data integrity and reliability is not guaranteed or required for such data, and data from the source will need to be rewritten. For example, such data can include data written from the next data source (e.g., written to one or more wordlines of the target block).

As yet another example, the target block can include an unwritten section. Ideally, data can be reliably appended to the unwritten section to avoid the target block copying previously written data. The potential impact on write amplification can be balanced with data integrity and reliability concerns.

At operation 530, processing logic determines whether to continue writing to the target block after the interrupt event. In some embodiments, determining whether to continue writing to the target block after the interrupt event includes determining whether a length of time that a target block has remained open satisfies a threshold condition. For example, processing logic can cause a scan to be performed to determine (e.g., indirectly determine) the length of time that the target block has remained open. In some embodiments, determining whether the length of time satisfies the threshold condition can include determining whether the length of time is less than or equal to a threshold amount of time. The threshold amount of time can correspond to a maximum amount of time that the target block should remain open for purposes of data integrity and reliability.

At operation 540, if processing logic determines to continue writing to the target block (e.g., the length of time is less than or equal to the threshold amount of time), then processing logic causes the write operation to continue to write data to the target block.

At operation 550, if processing logic determines not to continue writing to the target block (e.g., the length of time is greater than the threshold amount of time), then processing logic causes the target block to be abandoned. For example, causing the target block to be abandoned can include causing the target block to close to prevent further writes to the target block, opening a new target block, and migrating data written to the previously written data section of the target block to the new target block. Processing logic can then, at operation 540, cause the write operation to continue by initiating the write operation to write the data to the new target block.

Illustratively, in the case of an unpredicted interrupt event, there may be multiple options. For example, as a first option, processing logic at operation 540 can cause dummy data to be written to the interrupted programming section of a partially written target block for padding. In some embodiments, processing logic causes dummy data to be written to at least one wordline of the interrupted programming section. Processing logic can then cause writes to the target block to resume at the next wordline (the wordline adjacent to the last dummy data wordline). As another example, as a second option, processing logic at operation 550 can cause the target block to be abandoned. Processing logic can move data from the previously written data section (e.g., L2P mapped data) to the new target block. Processing logic can determine which option to perform by determining whether a length of time that a target block has remained open satisfies a threshold condition (e.g., similar to the process described above). If the length of time satisfies the threshold condition (e.g., is less than or equal to a threshold amount of time), then processing logic can keep the target block open and select the first option by causing the dummy data to be written to the interrupted programming section of the target block. Otherwise, processing logic can determine that the target block should be closed and select the second option to migrate the data from the previously written section of the target block to the new target block. Further details regarding operations 510-560 are described above with reference to FIGS. 1-4.

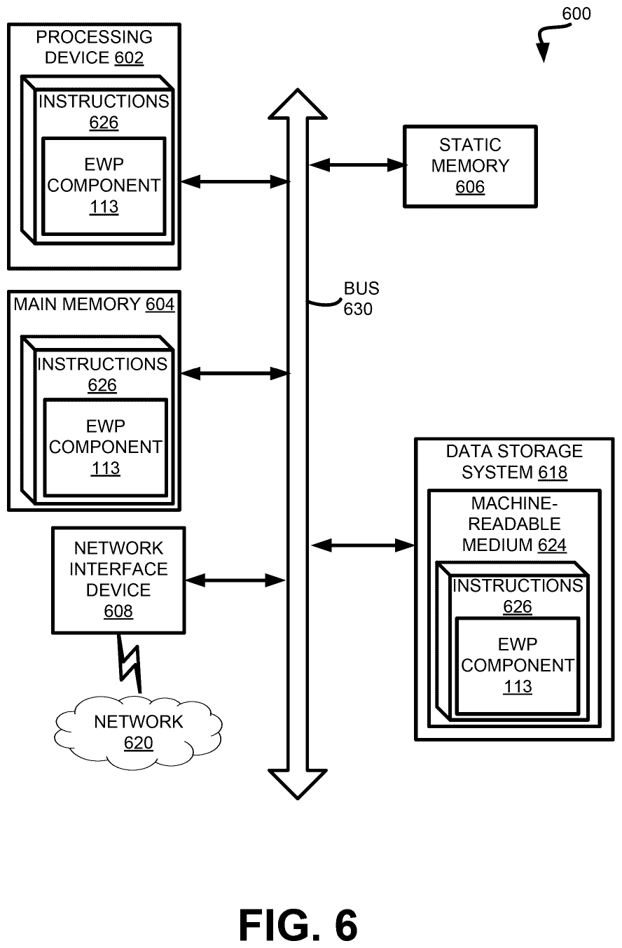

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the EWP component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to an EWP component (e.g., the EWP component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving data from a host system;
in response to receiving the data, initiating a write operation to write the data to a set of cache blocks of the memory device, the set of cache blocks comprising a first cache block and a second cache block;
determining whether the first cache block is fully written and whether an amount of data written to the second cache block is greater than or equal to a threshold amount of data; and
in response to determining that the first cache block is fully written and that the amount of data written to the second cache block is greater than or equal to the threshold amount of data, causing the data written to the set of cache blocks to be written to a target block of the memory device.

2. The system of claim 1, wherein the operations further comprise, after migrating the data written to the set of cache blocks to the target block:
updating a logical-to-physical (L2P) mapping table; and
initiating an erase operation to erase the first cache block.

3. The system of claim 1, wherein the first cache block comprises cells having a first type, and wherein the target block comprises cells having a second type different from the first type.

4. The system of claim 3, wherein the cells having the first type are single-level cells (SLC) cells, and the cells having the second type are quad-level cells (QLC) cells.

5. The system of claim 1, wherein the operations further comprise:
detecting an interrupt event with respect to data being written to the target block;
determining whether to continue writing to the target block after the interrupt event; and
in response to determining to continue writing to the target block after the interrupt event, causing the write operation to continue.

6. The system of claim 5, wherein the interrupt event comprises a power loss event.

7. The system of claim 5, wherein determining whether to continue writing to the target block after the interrupt event comprises determining whether a length of time that the target block has remained open satisfies a threshold condition.

8. A method comprising:
receiving, by a processing device, data from a host system;
in response to receiving the data, initiating, by the processing device, a write operation to write the data to a set of cache blocks of a memory device, the set of cache blocks comprising a first cache block and a second cache block;
determining, by the processing device, whether the first cache block is fully written and whether an amount of data written to the second cache block is greater than or equal to a threshold amount of data; and
in response to determining that the first cache block is fully written and that the amount of data written to the second cache block is greater than or equal to the threshold amount of data, causing, by the processing device, the data written to the set of cache blocks to be written to a target block of the memory device.

9. The method of claim 8, further comprising, after migrating the data written to the set of cache blocks to the target block:
updating, by the processing device, a logical-to-physical (L2P) mapping table; and
initiating, by the processing device, an erase operation to erase the first cache block.

10. The method of claim 8, wherein the first cache block comprises cells having a first type, and wherein the target block comprises cells having a second type different from the first type.

11. The method of claim 10, wherein the cells having the first type are single-level cells (SLC) cells, and the cells having the second type are quad-level cells (QLC) cells.

12. The method of claim 8, further comprising:
detecting, by the processing device, an interrupt event with respect to data being written to the target block;
determining, by the processing device, whether to continue writing to the target block after the interrupt event; and
in response to determining to continue writing to the target block after the interrupt event, causing, by the processing device, the write operation to continue.

13. The method of claim 12, wherein the interrupt event comprises a power loss event.

14. The method of claim 12, wherein determining whether to continue writing to the target block after the interrupt event comprises determining whether a length of time that a target block has remained open satisfies a threshold condition.

15. A non-transitory computer-readable storage medium comprising instructions that, when executed by a processing device, cause the processing device to perform operations comprising:
receiving data from a host system;
in response to receiving the data, initiating a write operation to write the data to a set of cache blocks of a memory device, the set of cache blocks comprising a first cache block and a second cache block;
determining whether the first cache block is fully written and whether an amount of data written to the second cache block is greater than or equal to a threshold amount of data; and
in response to determining that the first cache block is fully written and that the amount of data written to the second cache block is greater than or equal to the threshold amount of data, causing the data written to the set of cache blocks to be written to a target block of the memory device.

16. The non-transitory computer-readable storage medium of claim 15, wherein the operations further comprise, after migrating the data written to the set of cache blocks to the target block:
updating a logical-to-physical (L2P) mapping table; and
initiating an erase operation to erase the first cache block.

17. The non-transitory computer-readable storage medium of claim 15, wherein the first cache block comprises cells having a first type, and wherein the target block comprises cells having a second type different from the first type.

18. The non-transitory computer-readable storage medium of claim 15, wherein the operations further comprise:
detecting an interrupt event with respect to data being written to the target block;
determining whether to continue writing to the target block after the interrupt event; and
in response to determining to continue writing to the target block after the interrupt event, causing the write operation to continue.

19. The non-transitory computer-readable storage medium of claim 18, wherein the interrupt event comprises a power loss event.

20. The non-transitory computer-readable storage medium of claim 18, wherein determining whether to continue writing to the target block after the interrupt event comprises determining whether a length of time that a target block has remained open satisfies a threshold condition.
